(19) United States
(12) Patent Application Publication
(10) Pub. No.: US 2014/0369567 A1
(43) Pub. Date: Dec. 18, 2014

(54) Authorized Access Using Image Capture and Recognition System

(71) Applicant: Cyclops Technologies, Inc., (US)

(72) Inventors: John D. Chigos, Clearwater, FL (US); Wenbiao Wang, Tampa, FL (US)

(73) Assignee: Cyclops Technologies, Inc., Oldsmar, FL (US)

(21) Appl. No.: 13/773,611

(22) Filed: Feb. 21, 2013

Related U.S. Application Data
(63) Continuation-in-part of application No. 11/696,395, filed on Apr. 4, 2007, now abandoned.
Application No. 11/696,395 is a continuation-in-part of application No. 13/734,906, filed on Jan. 4, 2013.
(60) Provisional application No. 60/744,227, filed on Apr. 4, 2006.
(60) Provisional application No. 61/582,946, filed on Jan. 4, 2012.

(51) Int. Cl. G06K 9/32; G08B 25/01; H04N 7/18

(52) U.S. Cl. CPC G06K 9/325; H04N 7/183; G08B 25/01
USPC 382/105

(57) ABSTRACT

Provided is a system and method of electronically identifying a vehicle entering/leaving a predetermined geographical area by identifying a license plate and comparing the results to a predetermined database. The software aspect of the system runs on standard PC hardware and can be linked to other applications or databases. It first uses a series of image manipulation techniques to detect, normalize and enhance the image of the number plate. Optical character recognition (OCR) is used to extract the alpha-numeric characters of the license plate. The recognized characters are then compared to databases containing information about the vehicle and/or owner.

### CROSS REFERENCE TO RELATED APPLICATIONS

This application is a Continuation In Part of co-pending U.S. patent application Ser. No. 11/696,395, filed Apr. 4, 2007, which application claims priority to co-pending U.S. Provisional Application 60/744,227 filed Apr. 4, 2006, both of which are incorporated herein by reference in their entirety.

### FIELD OF THE INVENTION

This invention is directed to a system and method of capturing and recognizing images. More particularly, the invention relates to the fields of security monitoring, access control and/or law enforcement protection, among other fields.

### BACKGROUND OF THE INVENTION

A license plate recognition (LPR) system is a surveillance method that uses optical character recognition on images to read the license plates on vehicles. They can use existing closed-circuit television or road-rule enforcement cameras, or ones specifically designed for the task. They are used by various police forces and as a method of electronic toll collection on pay-per-use roads. LPR can be used to store the images captured by the cameras as well as the text from the license plate. Systems commonly use infrared lighting to allow the camera to take the picture at any time of day.

Many have attempted to automate the collection of license plate information. For example, U.S. Pat. No. 6,553,131 to Neubauer et al. describes a license plate recognition system using an intelligent camera. The camera is adapted to independently capture a license plate image and recognize the alpha-numeric characters within the image. The camera is equipped with a dedicated processor for managing the image data and executing the license plate recognition protocols. This system, however, requires the addition of dedicated equipment which increases the associated cost.

Similarly, U.S. Pat. No. 6,473,517 to Tyan et al. describes a character segmentation method for vehicle license plate recognition. This system also relies on dedicated hardware. Moreover, neither system allows the recognized characters to be compared to a predetermined database.

Therefore, what is needed is an automated license plate recognition system that is implemented in a software solution, rather than requiring dedicated hardware. The ideal solution should also allow the collected data to be compared to predetermined databases to provide the operator with real-time information.

### SUMMARY OF INVENTION

Various aspects of the invention overcome at least some of these and other drawbacks of existing systems. A client terminal device may be coupled to one or more peripheral devices, including imaging devices, radar guns, storage devices, and/or other peripheral devices. The peripheral devices may be coupled via a wired connection or a wireless connection. According to one embodiment of the invention, the imaging device may provide real-time video input sources, including real-time video feed or other real-time data. Alternatively, the imaging device may provide pre-recorded video data.

According to one embodiment of the invention, the imaging device may be utilized to capture information from objects, including vehicle license plates, container identifiers, and other objects. The objects may include identifiers, such as alpha numeric code, bar codes or other identifiers. According to one embodiment of the invention, the captured image data maybe processed by optical recognition software, such as optical character recognition (OCR) software or other optical recognition software. The optical recognition software may include an algorithm that analyzes and maintains information regarding misidentified data.

According to another embodiment of the invention, a recognition module may be provided that combines various types of data, such as bad image hit data, good image hit data, and other image data to provide average image hit data. According to one embodiment, the average image hit data may be used to derive best image. Additionally, a comparison module may perform various actions, including character substitution, character compensation, character additions, character deletions, and other actions. According to one embodiment of the invention, the recognition module may use neural networking techniques to self-train. For example, if the recognition module processes data and detects one or more patterns in which incorrect data was processed, the module may train itself to perform a second action rather than performing a first action. Alternatively, the EEC module may generate multiple character recognition combinations based on a single image. In this case, the comparison module may analyze various character recognition combinations against entries in a storage device and may select character recognition combinations that match one or more entries.

The invention provides numerous advantages over and avoids many drawbacks of prior systems. These and other objects, features, and advantages of the invention will be apparent through the detailed description of the embodiments and the drawings attached hereto. It is also to be understood that both the foregoing general description and the following detailed description are exemplary and not restrictive of the scope of the invention. Numerous other objects, features, and advantages of the invention should become apparent upon a reading of the following detailed description when taken in conjunction with the accompanying drawings, a brief description of which is included below.

### BRIEF DESCRIPTION OF THE DRAWINGS

For a fuller understanding of the nature and objects of the invention, reference should be made to the following detailed description, taken in connection with the accompanying drawings, in which:

FIG. 1 is a diagram of the architecture of the inventive system.

FIG. 2 is a block diagram showing peripheral connections in the inventive system.

FIG. 3 represents the output of the inventive software application.

FIG. 4A represents the output of the inventive software application after match was found between the target and a BOLO list.

FIG. 4B represents the output of the inventive software application after the user elects to respond to the alert generated in FIG. 4A.

FIG. 5 illustrates the polygon algorithm used to locate a license plate within a larger image.

FIG. 6 illustrates the recognition module and comparison module functional.

FIG. 7 is a block diagram of the application architect.

FIGS. 8A and 8B are graphs depicting the intensity and gradient of a given signal.

FIGS. 9A and 9B are graphic representations illustrating the concepts of pixel neighborhood and pixel connectedness.

FIG. 10 is a block diagram of the comparison module wherein a plurality of alternate recognition values is generated.

FIG. 11 represents the output the comparison module.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

### System Architecture

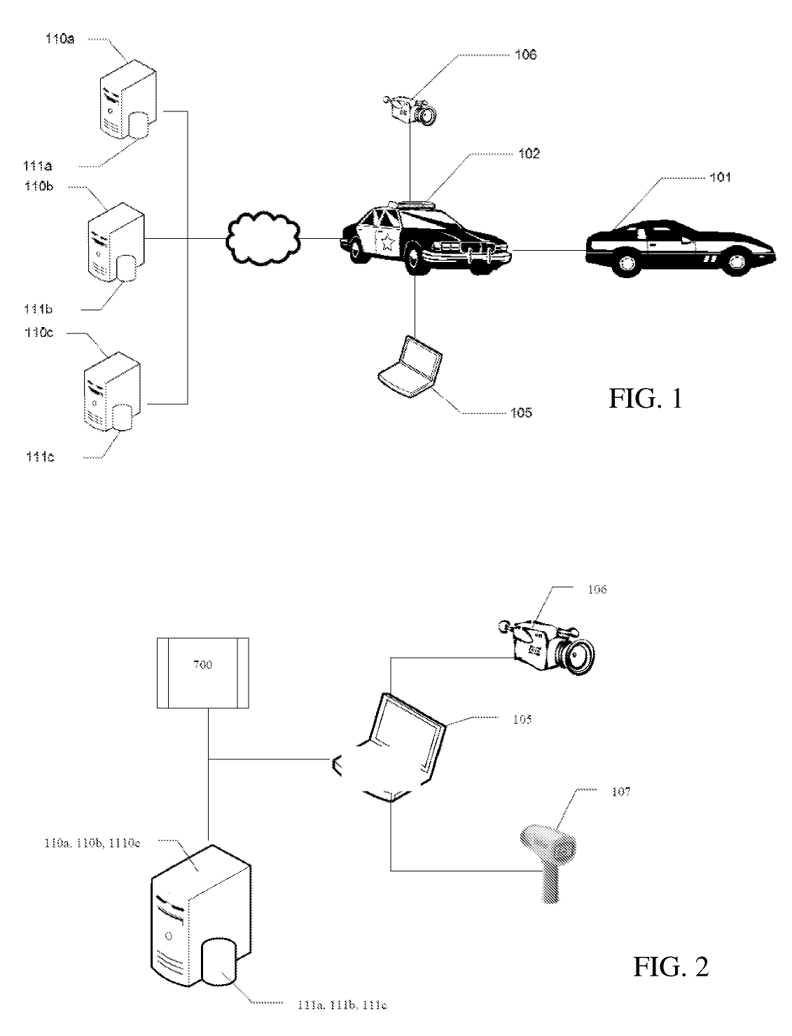

Referring now to FIG. 1, according to a preferred embodiment on the invention, imaging device 106, adapted to view target 101, is communicatively coupled to one or more client terminal devices 105 and one or more servers 110a, 110b, 110c (hereinafter server 110) are connected via a wired network, a wireless network, a combination of the foregoing and/or other network(s) (for example a local area network). Client terminal devices 105 may be located in mobile environments, such as vehicle 102 such as emergency response vehicles, non-emergency response vehicles, or other vehicles, or in stationary environments such as garages, gates, or other stationary environments. Servers 110 may be configured to store and transmit local jurisdiction database 111a, state law enforcement database 111b, or federal law enforcement database 111c, a security monitoring database, an access control database and/or other information.

Client terminal devices 105 may include any number of different types of client terminal devices, such as personal computers, laptops, smart terminals, personal digital assistants (PDAs), cell phones, kiosks, devices that combine the functionality of one or more of the foregoing or other client terminal devices. Additionally, client terminal devices 105 may include processors, RAMs, USB interfaces, a Fire Wire ports, IEEE 1394 ports, telephone interfaces, microphones, speakers, a stylus, a computer mouse, a wide area network interface, a local area network interface, a hard disk, wireless communication interfaces, a flat touch-screen display and a computer display, among other components.

Client terminal devices 105 may communicate with systems, including other client terminal devices, a computer system, servers 110 and/or other systems. Client terminal devices 105 may communicate via communications media, such as any wired and/or wireless media. Communications between client terminal devices 105, a computer system and/or server 110 may occur substantially in real-time if the system is connected to the network. One of ordinary skill in the art will appreciate that communications may be conducted in various ways and among various devices.

Alternatively, the communications may be delayed for an amount of time if, for example, one or more client terminal devices 105, the computer system and/or server 110 are not connected to the network. Here, any requests that are made while client terminal devices 105, the computer system and/or server 110 are not connected to the network may be stored and propagated from/to the offline device when the device is re-connected to network.

Upon connection to the network, server 110, the computer system and/or client terminal devices 105 may cause information stored in a storage device and/or memory, respectively, to be forwarded to the corresponding target device. However, during a time that the target client terminal device 105, the computer system, and/or server 110 are not connected to the network, requests remain in the corresponding client terminal device 105, the computer system, and/or server 110 for dissemination when the devices are re-connected to the network.

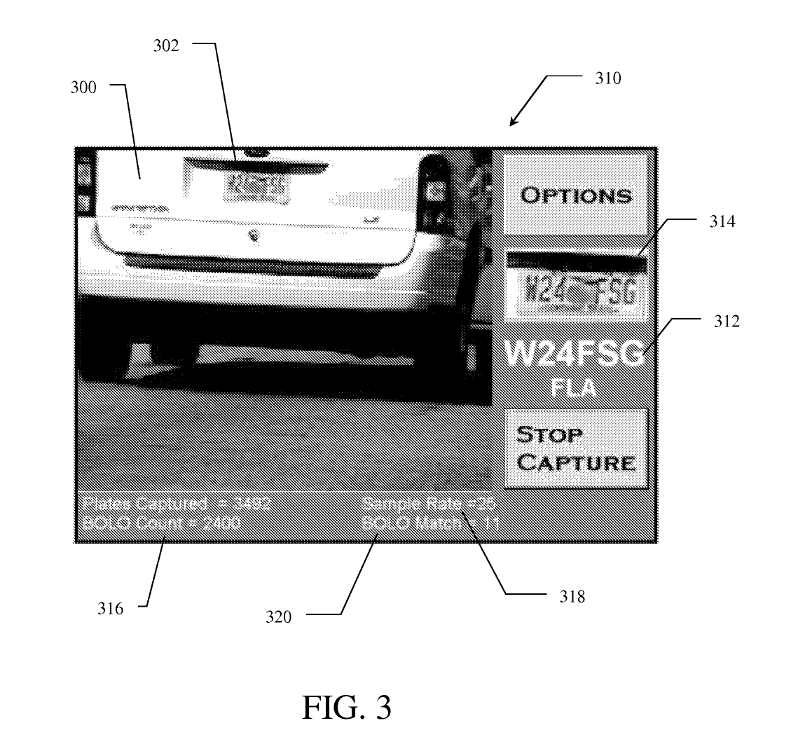

As illustrated in FIG. 2, client terminal device 105 may be coupled to one or more peripheral devices, including imaging device 106, radar guns 107, storage devices, and/or other peripheral devices. Peripheral devices may be coupled via a wired connection or a wireless connection. According to one embodiment of the invention, imaging device 106 may provide a real-time video input source, including real-time video feed or other real-time data. Alternatively, imaging device 106 may provide pre-recorded video data. According to another embodiment of the invention, imaging device 106 may provide heat detection information, including infrared imaging data and/or other heat detection information. One of ordinary skill in the art will readily appreciate that other imaging data may be gathered.

According to one embodiment of the invention, imaging device 106 maybe utilized to capture information from objects, including vehicle license plates, container identifiers, and other objects. The objects may include identifiers, such as alpha numeric code, bar codes or other identifiers. According to one embodiment, imaging device 106 may include known charge-coupled device (CCD) cameras that are used by law enforcement. According to another embodiment, a CCD camera may be positioned in a law enforcement vehicle to capture license plate images or other images. The CCD camera may include a lens having zoom capabilities or other capabilities that enable imaging of the license plate from a greater distance than is available to the unaided human eye. According to another embodiment, the invention may recognize any video source and any resolution that is sufficiently clear to recognize the images. One skilled in the art will readily appreciate that the invention may be implemented using various types of imaging devices.

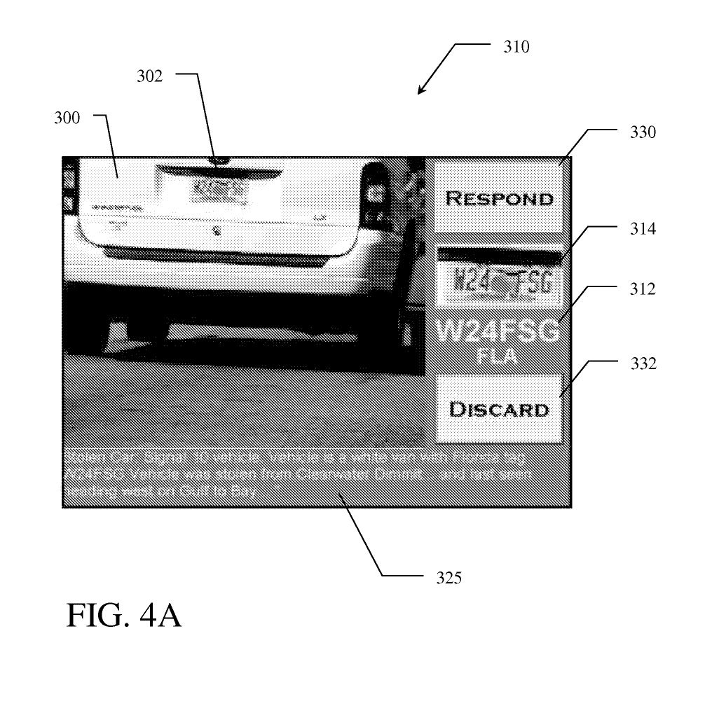

According to one embodiment of the invention, client terminal devices 105 may include, or be modified to include, software that operates to provide the desired functionality. Referring now to FIG. 3; while the software is running, any license plate that comes into the range of the camera is digitized and converted to data. The data is then displayed on the screen of the client terminal device. Background modules continuously compare all data captured against predetermined databases, such as Be-On-The-Lookout (BOLO) lists. As shown in FIG. 3, vehicle 300 having license plate 302 enters the range of view of the inventive system. License plate 302 is localized, digitized and displayed in screen 310 in frame 312 along with image 314 of license plate 302. In a preferred embodiment, screen 310 also displays the number of plates captured (316), sample rate 318 and the number of matches found 320 (discussed further below).

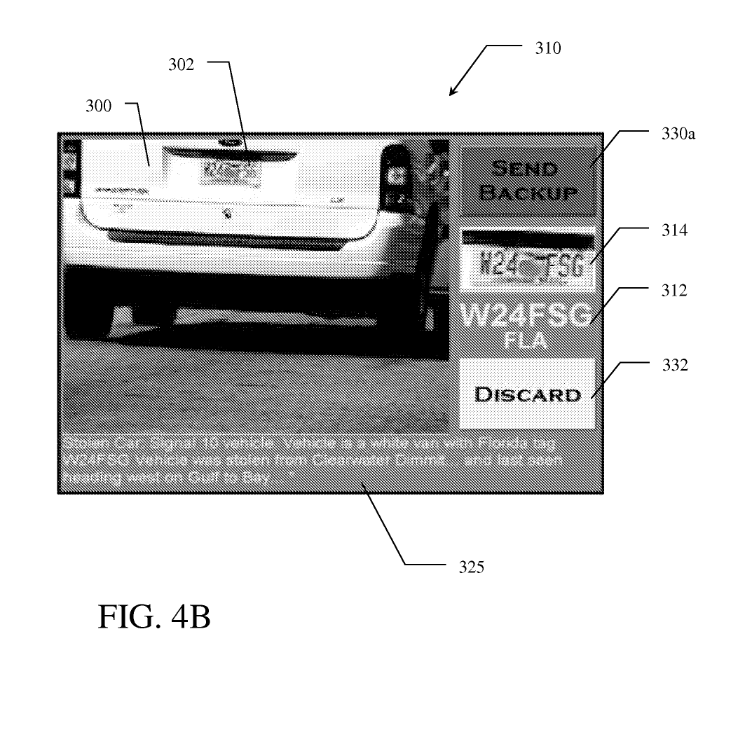

As shown in FIG. 4A, when a match is found between license plate 302 and the BOLO list, an audible alert is triggered and visual alert 325 is displayed on screen 310. In a preferred embodiment, respond button 330 and discard button 332 are also displayed responsive to a BOLO match. Selecting discard button 332 cancels the event and the system returns to scanning for new plates. Selecting respond button 330 creates a time and date stamp and transmits the captured information to a central database. Upon selection, respond button 330 changes to send backup button 330a which triggers an automatic request for assistance accompanied by the captured information, which may include the user's location.

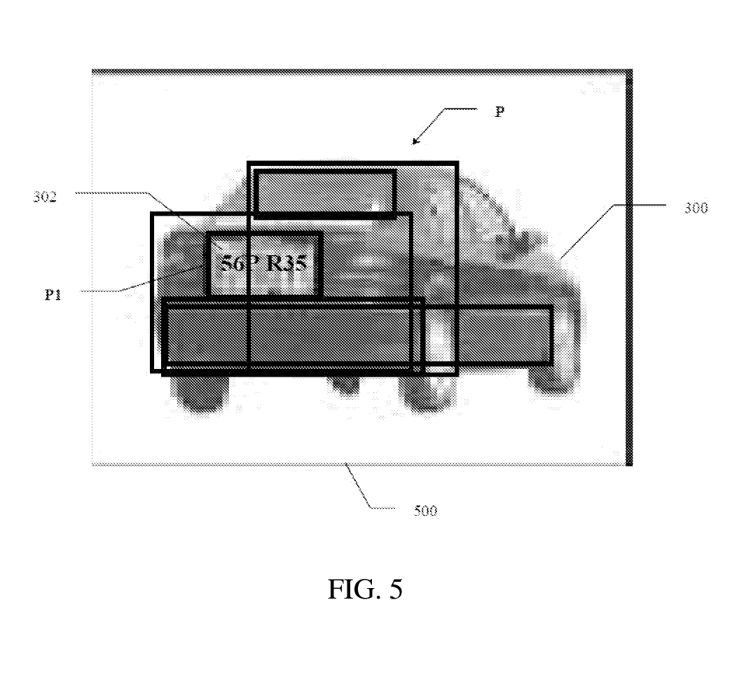

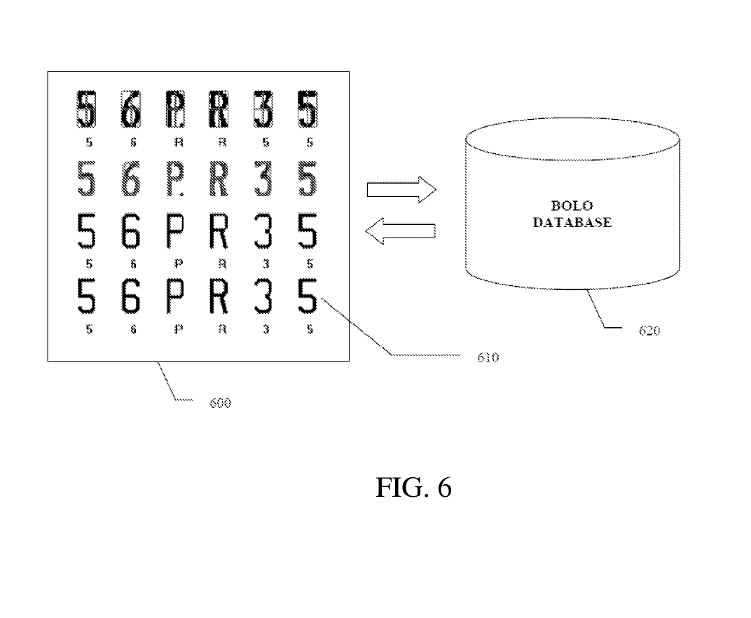

FIGS. 5 and 6 provide an overview of how the license plate is located within the video stream and converted to data, in the form of a recognition value. Referring now to FIG. 5; vehicle 300 having license plate 302 enters the field of view of the imaging device attached to client terminal device 105 (not shown). A video stream is transmitted from the imaging device to client terminal device 105. A still image 500, such as a bitmap, is extracted from the video stream by software running on client terminal device 105. A localization module (discussed below) uses a powerful polygon algorithm to detect the position of license plate 302 within captured image 500 by creating a number of polygons (P) and searching for alpha-numeric characters therein. Polygons (P) corresponding to the known parameters of a license plate, and which contain alpha-numeric characters, such as polygon P1 are selected by the software architecture. The alpha-numeric characters are then extracted. If no polygons (P) are detected which match the necessary criteria, image 500 is discarded and the system continues to scan for a new plate.

In FIG. 6, the extracted alpha-numeric characters are converted, processed and refined in the recognition module (discussed below). The characters are processed through pixel comparison 600 until the individual characters are recognized and produced as recognition value 610. A comparison module compares derived recognition value 610 against database 620 to search for a potential match. If a match is found, the system triggers an audible and visual alert as discussed above.

### Software Architecture

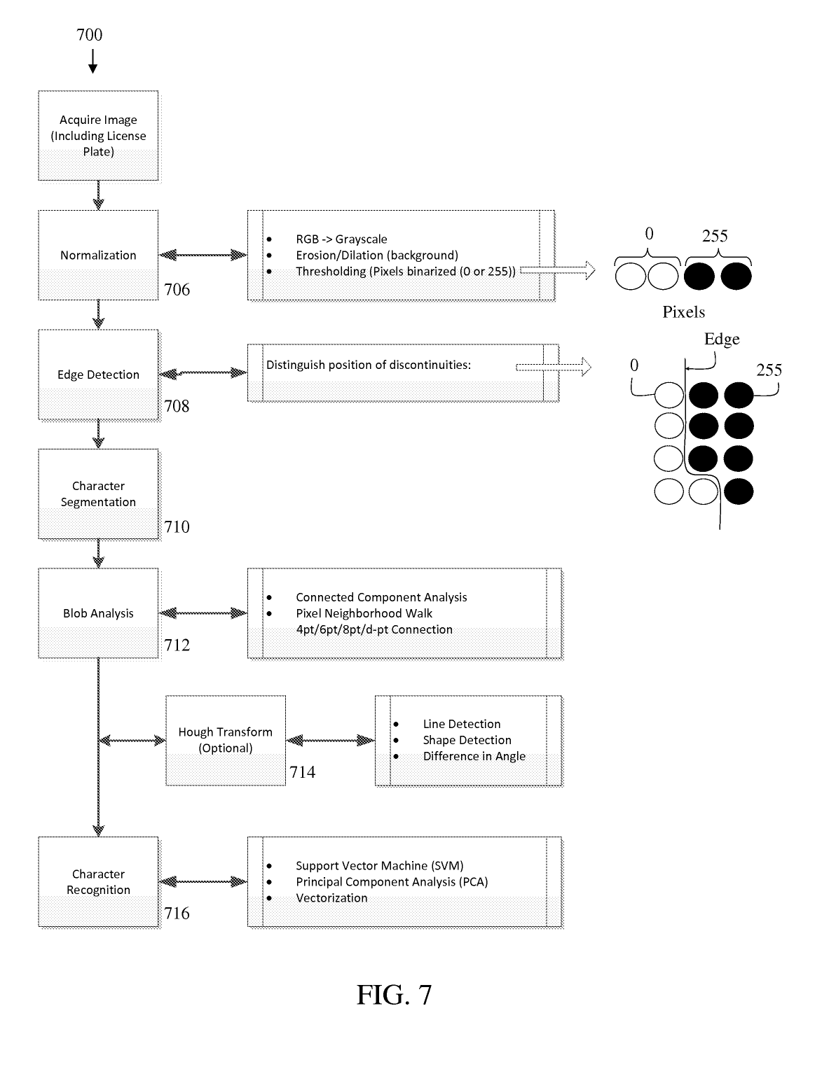

The software running on Client terminal device 105 is preferably of modular construction, as discussed above, to facilitate adding, deleting, updating and/or amending modules therein and/or features within modules. Modules may include software, memory, or other modules. It should be readily understood that a greater or lesser number of modules might be used. One skilled in the art will readily appreciate that the invention may be implemented using individual modules, a single module that incorporates the features of two or more separately described modules, individual software programs, and/or a single software program. In a preferred embodiment, as shown in FIG. 7, software application 700 comprises video capture module 702, image extraction module 704, normalization module 706, edge detection module 708, segmentation module 710, blob analysis module 712, optional Hough Transform module 714 and character recognition module 716.

Video capture module 702 acquires images, such as real-time streaming video, from the imaging device using video drivers native to the operating system of client terminal device 105. Any compatible video source/camera compatible with the operating system on which the inventive software is running can be used. Therefore, the invention does not require new or dedicated hardware. The video source is capable of originating from existing sources, including but not limited to 1394 fire wire, USB2, AVI, Bitmap, and or sources hanging on a network. Video module 702 is adapted to recognize any video source and any resolution that is sufficiently clear to recognize the images provided thereby. One skilled in the art will readily appreciate that the invention may be implemented using various types of imaging devices.

Image extraction module 704 scans the input from the imaging device and extracts still images. In a preferred embodiment, image extraction module 704 extracts still images (such as a bitmap, tiff or jpeg) from a real-time video stream transmitted by the imaging device.

Normalization module 706 changes the range of pixel intensity values in the extracted images to a value of 0 (zero) or 255 for each pixel. Moreover, the image is converted from RGB to grayscale. This process alleviates issues with difficult imaging conditions (such as poor contrast due to glare, for example). The function of the normalization module is to achieve consistency in dynamic range for a set of data, signals, or images.

Normalization is a linear process. If the intensity range of the image is 50 to 180 and the desired range is 0 to 255 the process entails subtracting 50 from each of pixel intensity, making the range 0 to 130. Then each pixel intensity is multiplied by 255/130, making the range 0 to 255. Auto-normalization in image processing software typically normalizes to the full dynamic range of the number system specified in the image file format.

Normalization module 706 is also responsible for erosion and dilation functions. The basic morphological operations, erosion and dilation, produce contrasting results when applied to either grayscale or binary images. Erosion shrinks image objects while dilation expands them. The specific actions of each operation are covered in the following sections.

Erosion generally decreases the sizes of objects and removes small anomalies by subtracting objects with a radius smaller than the structuring element. With grayscale images, erosion reduces the brightness (and therefore the size) of bright objects on a dark background by taking the neighborhood minimum when passing the structuring element over the image. With binary images, erosion completely removes objects smaller than the structuring element and removes perimeter pixels from larger image objects.

Dilation generally increases the sizes of objects, filling in holes and broken areas, and connecting areas that are separated by spaces smaller than the size of the structuring element. With grayscale images, dilation increases the brightness of objects by taking the neighborhood maximum when passing the structuring element over the image. With binary images, dilation connects areas that are separated by spaces smaller than the structuring element and adds pixels to the perimeter of each image object.

Edge detection module 708 provides, inter alia, detection of changes in image brightness to capture important events and changes in properties of the captured image. Edges are areas where the goal is to identify points in an image which the image brightness changes sharply or has discontinuities in the pixel values.

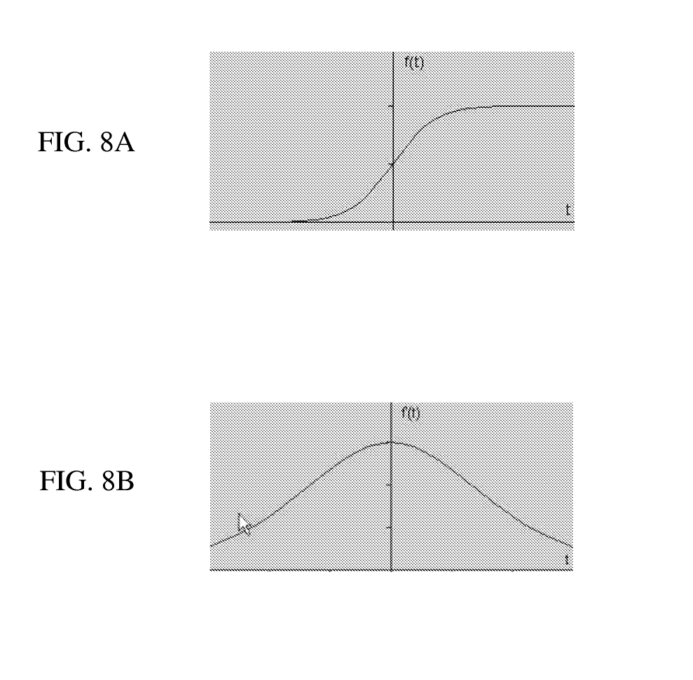

Edges characterize boundaries and are therefore a problem of fundamental importance in image processing. Edges in images are areas with strong intensity contrasts—a jump in intensity from one pixel to the next. Edge detecting an image significantly reduces the amount of data and filters out useless information, while preserving the important structural properties in an image. There are many ways to perform edge detection. However, the majority of different methods may be grouped into two categories, gradient and Laplacian. The gradient method detects the edges by looking for the maximum and minimum in the first derivative of the image. The Laplacian method searches for zero crossings in the second derivative of the image to find edges. An edge has the one-dimensional shape of a ramp and calculating the derivative of the image can highlight its location. Take, for example, the signal shown in FIG. 8A, with an edge shown by the jump in intensity. If one takes the gradient of this signal (which, in one dimension, is the first derivative with respect to t) one gets the result shown in FIG. 8B

### Segmentation Module 710

Blob analysis module 712 is aimed at detecting points and/or regions in the image that are either brighter or darker than the surrounding. There are two main classes of blob detectors (i) differential methods based on derivative expressions and (ii) methods based on local extrema in the intensity landscape. Image processing software comprises complex algorithms that have pixel values as inputs. For image processing, a blob is defined as a region of connected pixels. Blob analysis is the identification and study of these regions in an image. The algorithms discern pixels by their value and place them in one of two categories: the foreground (typically pixels with a non-zero value) or the background (pixels with a zero value). In typical applications that use blob analysis, the blob features usually calculated are area and perimeter, Feret diameter, blob shape, and location. Since a blob is a region of touching pixels, analysis tools typically consider touching foreground pixels to be part of the same blob. Consequently, what is easily identifiable by the human eye as several distinct but touching blobs may be interpreted by software as a single blob. Furthermore, any part of a blob that is in the background pixel state because of lighting or reflection is considered as background during analysis.

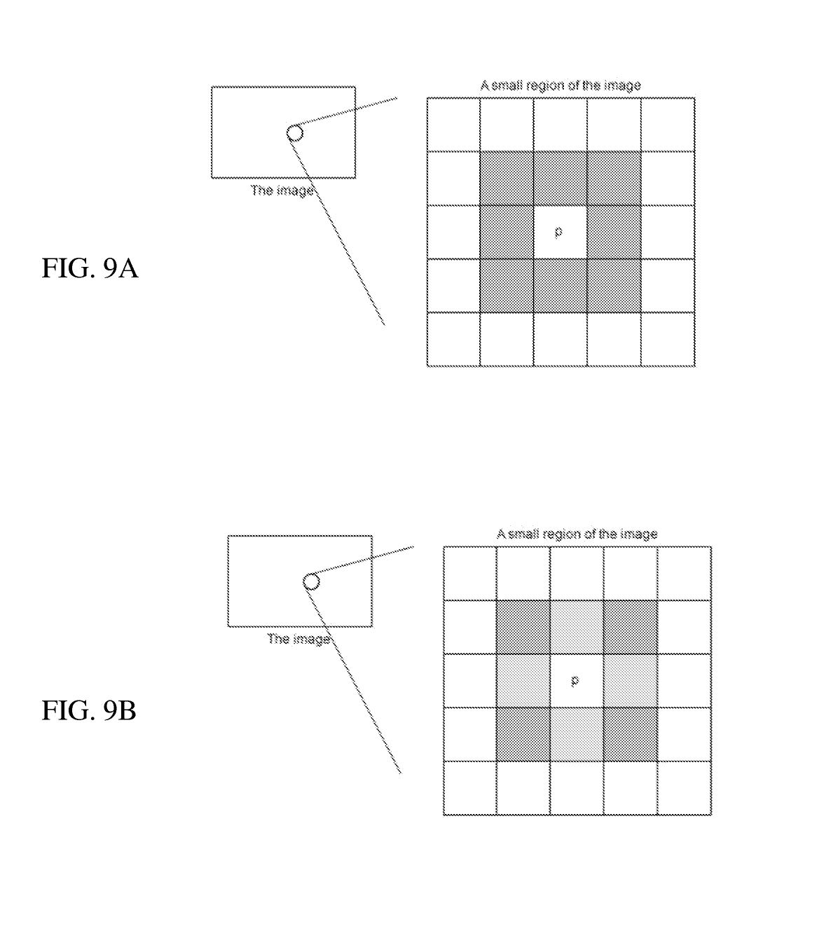

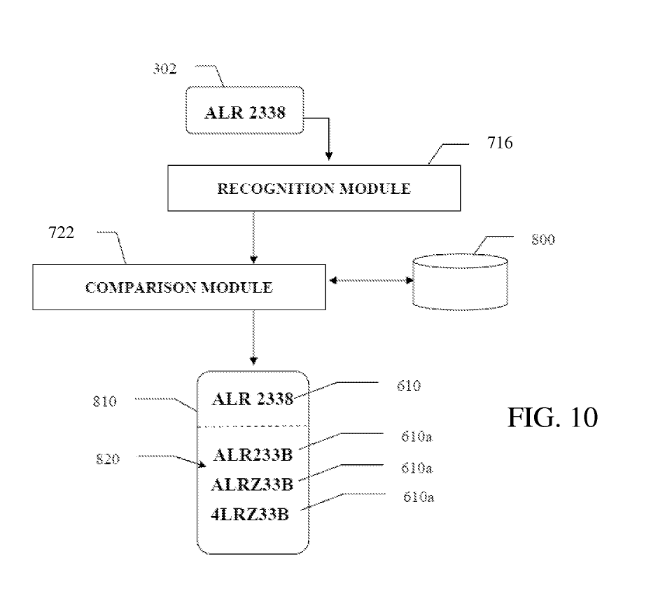

Blob analysis module 712 utilizes pixel neighborhoods and connectedness. The neighborhood of a pixel is the set of pixels that touch it. Thus, the neighborhood of a pixel can have a maximum of 8 pixels (images are always considered 2D). See FIG. 9A, where the shaded area forms the neighborhood of the pixel “p”.

Referring to FIG. 9B, two pixels are said to be “connected” if they belong to the neighborhood of each other. All the shaded pixels are “connected” to ‘p’ . . . or, they are 8-connected to p. However, only the green ones are ‘4-connected to p. And the orange ones are d-connected to p. If one has several pixels, they are said to be connected if there is some “chain-of-connection” between any two pixels.

Hough transform module 714 is optional. The Hough transform is a technique which can be used to isolate features of a particular shape within an image. Because it requires that the desired features be specified in some parametric form, the classical Hough transform is most commonly used for the detection of regular curves such as lines, circles, ellipses, etc. A generalized Hough transform can be employed in applications where a simple analytic description of a feature(s) is not possible. Due to the computational complexity of the generalized Hough algorithm, we restrict the main focus of this discussion to the classical Hough transform.

The Hough technique is particularly useful for computing a global description of a feature(s) (where the number of solution classes need not be known a priori), given (possibly noisy) local measurements. The motivating idea behind the Hough technique for line detection is that each input measurement (e.g. coordinate point) indicates its contribution to a globally consistent solution (e.g. the physical line which gave rise to that image point).

Character recognition module 716 utilizes technologies such as Support Vector Machine (SVM), Principal Component Analysis (PCA) and vectorization to identify and extract the characters from the still images. For example, Principal component analysis (PCA) is a mathematical procedure that uses an orthogonal transformation to convert a set of observations of possibly correlated variables into a set of values of uncorrelated variables called principal components. The number of principal components is less than or equal to the number of original variables.

In an illustrative embodiment, the steps of computing PCA using the covariance method include:
1. Organize the data set
2. Calculate the empirical mean
3. Calculate the deviations from the mean
4. Find the covariance matrix
5. Find the eigenvectors and eigenvalues of the covariance matrix
6. Rearrange the eigenvectors and eigenvalues
7. Compute the cumulative energy content for each eigenvector
8. Select a subset of the eigenvectors as basis vectors

The character recognition module 716 extracts the alpha-numeric characters identified in the still image and runs a pixel comparison of the extracted characters in a back-propagated neural network, which are known (see C. Bishop, Neural Networks for Character Recognition, Oxford University Press, 1995; and C. Leondes, Image Processing and Pattern Recognition (Neural Network Systems Techniques and Applications), Academic Press, 1998, which are incorporated herein by reference), to search for a match. Once this process is completed, recognition module 716 generates a recognition value derived from the extracted characters which is then stored in a remote database.

The use of neural networking techniques allows recognition module 716 to “self-train.” That is, if recognition module 716 processes data and detects one or more patterns in which incorrect data was processed, it may train itself to perform a second action rather than performing a first action. Alternatively, recognition module 716 may generate multiple character recognition combinations based on a single image. In this case the module may analyze various character recognition combinations against entries in a storage device and may select character recognition combinations that match one or more entries. The selected character recognition combinations may be used to search for additional information that is associated with the selected character recognition combinations.

The invention can also employ Environmental compensation module 720 can also be employed to address inconsistencies arising from, inter alia, illumination discrepancies, position (relative to imaging device), tilt, skew, rotation, blurring, weather and other effects. Here, the polygon recognition and character recognition algorithms work in parallel to identify a license plate within the captured image. Compensation module 720 may compensate for varying conditions, including weather conditions, varying lighting conditions, and/or other conditions. For example, compensation module 720 may perform filtering, including light filtering, color filtering and/or other filtering. For example, color filtering may be used to provide more contrast to an image. Additionally, compensation module 720 may contain motion compensation processors that enhance data that is captured from moving platforms. Image enhancement may also be performed on images taken from stationary platforms.

The inventive system may also capture information in addition to alpha-numeric characters. The imaging device may capture jurisdiction, state information, alpha numeric information, or other information that is taken from a vehicle license plate. For example, recognition module 716 may be programmed to recognize graphical images common on license plates, including an orange, a cactus, the Statue of Liberty and/or other graphical images. Based on the image recognition capabilities, recognition module 716 may recognize the Statue of Liberty on a license plate and may identify the license plate as a New York state license plate.

In another embodiment of the invention, the imaging device may capture additional vehicle information, such as vehicle color, make, model, or other vehicle information. The vehicle color information may be cross-referenced with other captured license plate information to provide additional assurance of correct license plate information. According to another embodiment of the invention, the vehicle color information may be used to identify if a vehicle license plate was switched between two vehicles. One of ordinary skill in the art will readily recognize that the captured vehicle information may be processed in various ways.

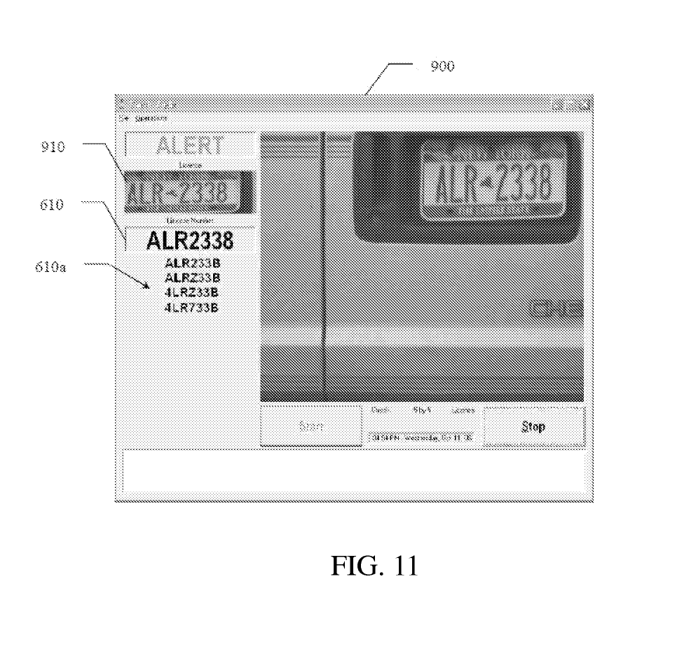

Comparison module 722 searches any predetermined database, such as BOLO list, for possible matches with the recognition value. Moreover, comparison module 722 generates alternate recognition values by merging the recognition value with a letter substitution table. This procedure substitutes common mistakenly read characters with values stored on the table. For example, the substitution table may recognize that the character “I” is commonly misread as “L,” “1” or “T” (or vice versa) or that “O” is commonly misread as “Q” or “0” (or vice versa). For example, shown in FIG. 11, license plate 302 contains the characters ALR 2388. The extracted characters are processed by comparison module 722 which compares the characters to substitution table 800. The system then generates output 810 which contains recognition value 610, determined by recognition module 716, and list 820 of alternate recognition values. In a preferred embodiment, as shown in FIG. 11, the system launches a screen 900 with picture 910 of the plate in question as well as recognition value 610 and alternate recognition values 610a. The user can then select which value represents what is seen, or choose to discard all values.

Additionally, any database used in conjunction with the invention may be configured to provide alert and/or notification escalation. Here for example, an alert or other action may be automatically escalated up from a local level to Federal level depending on various factors including the database that is accessed, a description of the vehicle, a category of the data, or other factors. The escalation may be from local law enforcement to Federal law enforcement. According to one embodiment of the invention, the escalation may be performed without intervention by a human operator. According to another embodiment of the invention, the alert or other action may be processed and provided to varying agencies on a need-to-know basis in real-time.

Given the contemplated mobile environment for the invention, the user interface may include user-friendly navigation, including touch screen navigation, voice recognition navigation, command navigation and/other user-friendly navigation. Additionally, alerts, triggers, alarms, notifications and/or other actions, may be provided through text to speech recognition systems. According to one embodiment, the invention enables total hands-free operation.

According to another embodiment, the invention may enable integration of existing systems. For example, output from a radar gun may be over-laid onto a video image. As a result, information, including descriptive text, vehicle speed, and other information may be displayed over a captured vehicle image. For example, the vehicle image, vehicle license plate information and vehicle speed may be displayed on a single output display. According to one embodiment, the invention may provide hands-free operation to integrated systems, wherein the existing systems did not offer hands-free operation.

In an alternate embodiment, an escalation module may be configured to perform various actions, including generating alerts, triggers, alarms, notifications and/or other actions. According to one embodiment of the invention, the data may be categorized to enable creation of response automation standards. For example, data categories may include an alert, trigger, alarm, notification and/or other category. According to one embodiment of the invention, the notification category may be subject to different criteria than the trigger category. Additionally, the database may be configured to provide alert and/or notification escalation. According to one embodiment of the invention, an alert or other action may be automatically escalated up from a local level to Federal level depending on various factors.

According to another embodiment, the user interface may include user-friendly navigation, including touch screen navigation, voice recognition navigation, command navigation and/other user-friendly navigation. Additionally, alerts, triggers, alarms, notifications and/or other actions, may be provided through text to speech recognition systems. According to one embodiment, the invention enables total hands-free operation.

According to another embodiment, a method is provided for allowing law enforcement agencies, security monitoring agencies and/or access control companies to accurately identify vehicles in real time, without delay. The invention reduces voice communication traffic, thus freeing channels for emergencies. According to another embodiment, the invention provides a real-time vehicle license plate reading system that includes identification technology coupled to real time databases through which information may be quickly and safely scanned at a distance.

### Access Control Module

In another embodiment, the inventive system is communicatively coupled with at least one stationary image capture device. Image capture device is mounted at/near the entrance/exit to a secured area. Examples of secured areas having controlled access include, gated parking lots, gated communities and secure government facilities. Device is positioned to view the rear of any vehicle approaching the entrance/exit to the controlled access area. Of course this system can also be adapted to authorize egress from a given area as well.

A database of authorized vehicles is maintained and in communication with the inventive system. The system is initiated as the vehicle approaches the gateway. The vehicle identification information is compared to the authorized vehicle database. If a match is found, the system electronically activates the gate thereby authorizing entrance to the secure area. If a match is not found the system does not open the gate and instead can be adapted to send an alert notifying necessary personnel that intervention is necessary.

Additionally, all vehicle identification is maintained in a database. This information can be used to determine if a particular unauthorized vehicle has made several attempts to enter the area. This information can also be sent to the intervening personnel.

Moreover, the authorized vehicle information can be associated with routing information. This information can be transmitted to a display near the entrance once the vehicle has entered the secure area. Alternatively, the display can be a wireless device within the vehicle.

For example, an authorized transport is scheduled to stop at the third floor of a parking garage. Upon pulling up to the gate, the system compares the vehicle identification information to the authorized vehicle database and finds a positive match. Associated with the vehicle identification information are instructions to proceed to third floor of the parking garage. In response, the inventive system sends a first signal opening the gate. A second signal is sent to a display in view of the vehicle with the instructions “Proceed to Third Floor.”

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between. Now that the invention has been described,

What is claimed is:

1. A non-transitory computer readable medium having computer executable instructions for performing a method comprising:
a. a computer for executing said instructions;
b. maintaining a database of predetermined authorized vehicle identification values;
c. capturing an image of a vehicle approaching a predetermined limited access area, having at least one electronically actuated obstacle barring entrance thereto, from at least one image capture device in communication the computer;
d. projecting a plurality of polygons onto the captured image;
e. capturing at least one polygon projected on the captured image responsive to the detection of the presence of alpha-numeric characters within the at least one of the plurality of polygons projected onto the captured image;
f. establishing a recognition value derived from the alpha-numeric characters within the at least one detected polygon;
g. storing the recognition value; comparing the recognition value to the predetermined identification values;
h. transmitting a signal to the electronically actuated obstacle responsive to a match between the recognition value and a value in the database of predetermined authorization values.

2. The method of claim 1 further comprising establishing a character substitution table comprising a plurality of commonly mistaken character reads; and creating a plurality of altered recognition values derived from the recognition value and the character substitution table.

3. The method of claim 2, further comprising displaying the image containing alphanumeric characters with the plurality of altered recognition values.

4. The method of claim 1 wherein the database of predetermined identification values is selected from the group consisting of local law enforcement databases, state law enforcement databases, federal law enforcement databases, security monitoring databases and access control databases.

5. The method of claim 1 wherein the imaging device is selected from the group consisting of cameras, digital cameras, charged-coupled devices, video cameras and scanners.

6. The method of claim 1 wherein the imaging device is a real time video input source.

7. The method of claim 1 wherein the image containing alpha-numeric characters is captured from a video stream.

8. The method of claim 1 wherein the image is selected from the group consisting of a bitmap, tagged image file format and a jpeg.

9. The method of claim 1 wherein the recognition value is established by a method comprising:
a. identifying a license plate within the captured image;
b. detecting a plurality of alpha-numeric characters within the license plate;
c. extracting the alpha-numeric characters from the captured image;
d. processing the extracted characters in a back-propagated neural net to calculate the recognition value derived from the alpha-numeric characters within the at least one detected polygon; and
e. exporting the recognition value.

10. The method of claim 1, further comprising the step of transmitting a signal to a display in view of the vehicle responsive to a match between the recognition value and a value in the database of predetermined authorization values.

11. The method of claim 1, further comprising the step of generating an alert responsive to no match between the recognition value and a value in the database of predetermined authorization values being found.

12. The method of claim 11, further comprising the step of storing the vehicle identification information

13. The method of claim 1, wherein the alert is generated responsive to the vehicle captured in the image entering the predetermined geographical area.

14. The method of claim 1, wherein the alert is generated responsive to the vehicle captured in the image leaving the predetermined geographical area.

15. A method of electronically identifying a license plate, comprising:
a. capturing an image containing the license plate using a plurality of image capture devices positioned within a predetermined geographical area;
b. localizing the license plate within the image by identifying at least one polygon within the image containing alpha-numeric characters;
c. recognizing a plurality of characters in the license plate; and
d. comparing the recognized plurality of characters to a predetermined database comprising vehicle identification values.

16. The method of claim 13 wherein the image of the license plate is captured from a video stream.

17. The method of claim 15 wherein the plate is localized by detecting at least one substantially rectangular polygon within the image that contains alpha-numeric characters.

18. The method of claim 15 wherein the plurality of characters are recognized by performing a pixel comparison of the characters in back-propagated neural network.

19. The method of claim 15 further comprising: establishing a character substitution table comprising a plurality of commonly mistaken character reads; and creating a plurality of altered recognition values derived from the recognition value and the character substation substitution table.

20. The method of claim 19, further comprising displaying the image containing alphanumeric characters with the plurality of altered recognition values.
